(19) United States
(12) Patent Application Publication
(10) Pub. No.: US 2023/0112790 A1
(43) Pub. Date: Apr. 13, 2023

(54) SIGNAL PROCESSING METHOD AND DEVICE FOR ULTRASONIC INSPECTION AND THICKNESS MEASURING METHOD AND DEVICE

(71) Applicant: MITSUBISHI HEAVY INDUSTRIES, LTD., Tokyo (JP)

(72) Inventors: Keiichi Morishita, Tokyo (JP); Kenji Iizuka, Tokyo (JP); Kentaro Jinno, Tokyo (JP)

(73) Assignee: MITSUBISHI HEAVY INDUSTRIES, LTD., Tokyo (JP)

(21) Appl. No.: 17/798,497

(22) PCT Filed: Feb. 10, 2021
(86) PCT No.: PCT/JP2021/005029

§ 371 Date: Aug. 9, 2022

(30) Foreign Application Priority Data
Feb. 19, 2020 (JP) 2020-026635

(51) Int. Cl. G01N 29/44; G01N 29/04; G01N 29/40

(52) U.S. Cl. CPC G01N 29/4454; G01N 29/043; G01N 29/40; G01N 2291/02854

(57) ABSTRACT

A signal processing method for ultrasonic inspection includes: a step of generating ultrasonic waves by driving an ultrasonic probe by using a plurality of burst wave signals with different frequencies, respectively, and causing the ultrasonic waves to inject an inspection target; a receiving step of receiving a plurality of multiple reflected waves corresponding to the plurality of burst wave signals having injected the inspection target, respectively; a step of obtaining a plurality of detection signals by executing detection processing of receiving signals of the plurality of multiple reflected waves corresponding to the plurality of burst wave signals, respectively; and a generating step of generating an inspection signal for obtaining an inspection result related to the inspection target by using the plurality of detection signals.

### TECHNICAL FIELD

This disclosure relates to a signal processing method and device for ultrasonic inspection and thickness measuring method and device.

### BACKGROUND

In ultrasonic inspection, an ultrasonic probe is driven by an electric signal so as to generate ultrasonic waves and to cause them to inject an inspection target, a reflective wave from the inspection target is converted to the electric signal and received, and a thickness, a distance and the like are measured on the basis of time from incidence of the ultrasonic waves to reception of the reflected wave. As the electric signal for driving the ultrasonic probe, it is known that an impulse or a burst wave signal, for example, is used.

Patent Literature 1 discloses an ultrasonic image apparatus using the burst wave signal as a transmitted signal which drives the ultrasonic probe.

### CITATION LIST

### Patent Literature

### Patent Document 1: JP2003-107059A

### SUMMARY

### Technical Problem

By the way, when the ultrasonic probe is driven by using the burst wave signal, energy efficiency of the signal caused to inject the ultrasonic probe is higher as compared with a case where the impulse with wide frequency response is used. Therefore, measurement can be made by using an electric signal with a lower voltage, and it can be applied easily to a use under an inflammable gas atmosphere, for example. On the other hand, when the ultrasonic probe is driven by using the burst wave signal, a level of a detection signal based on the reflected wave is changed in accordance with a thickness, a frequency and the like of the inspection target, and there are measurement values (thickness and the like) whose detection voltage is in the vicinity of zero. Thus, the inspection target cannot be measured appropriately in some cases.

In view of the aforementioned circumstances, at least one embodiment of the present invention has an object to provide a signal processing method and a device for ultrasonic inspection and a thickness measurement method and a device which can measure an inspection target appropriately.

### Solution to Problem

A signal processing method for ultrasonic inspection according to at least one embodiment of the present invention includes

a step of generating ultrasonic waves by driving an ultrasonic probe by using a plurality of burst wave signals with different frequencies, respectively, and causing the ultrasonic waves to inject an inspection target,

a receiving step of receiving a plurality of reflected waves corresponding to the plurality of burst wave signals having injected the inspection target, respectively,

a step of obtaining a plurality of detection signals by executing detection processing of receiving signals of the plurality of reflected waves corresponding to the plurality of burst wave signals, respectively, and

a generating step of generating an inspection signal for obtaining an inspection result related to the inspection target by using the plurality of detection signals.

Moreover, a thickness measuring method according to at least one embodiment of the present invention includes

a step of obtaining the inspection signal by the signal processing method; and

a step of determining a thickness of the inspection target by using the inspection signal.

Moreover, a signal processing device for an ultrasonic inspection according to at least one embodiment of the present invention includes

a burst wave oscillator configured to be capable of oscillating a plurality of burst wave signals with different frequencies,

an ultrasonic probe configured to generate ultrasonic waves by being driven by the burst wave signals so as to cause the ultrasonic waves to inject an inspection target and to receive reflected waves from the inspection target,

an inspection processing unit configured to execute inspection processing of receiving signals of the plurality of reflected waves corresponding to each of the plurality of burst wave signals and to obtain a plurality of detection signals, and

an inspection-signal generating unit generating an inspection signal for obtaining an inspection result related to the inspection target by using the plurality of detection signal.

Moreover, a thickness measuring device according to at least one embodiment of the present invention includes

the aforementioned signal processing device, and

a thickness calculation unit configured to calculate a thickness of the inspection target by using the inspection signal obtained by the signal processing device.

### Advantageous Effects

According to at least one embodiment of the present invention, a signal processing method and a device for ultrasonic inspection and a thickness measuring method and a device which can measure an inspection target appropriately are provided.

### BRIEF DESCRIPTION OF DRAWINGS

FIG. 1 is a schematic configuration diagram of a thickness measuring device including a signal processing device for ultrasonic inspection according to an embodiment.

FIG. 2 is a flowchart of the signal processing method according to the embodiment.

FIG. 3A is a diagram illustrating an example of a waveform of a burst wave signal used in the signal processing method according to the embodiment.

FIG. 3B is a diagram illustrating an example of the waveform of the burst wave signal used in the signal processing method according to the embodiment.

FIG. 4 is a diagram illustrating an example of a waveform of a receiving signal obtained in a process of the signal processing method according to the embodiment.

FIG. 5 is a diagram illustrating an example of the waveform of the signal obtained in the process of inspection processing in the signal processing method according to the embodiment.

FIG. 6 is a diagram illustrating an example of the waveform of the signal obtained in the process of inspection processing in the signal processing method according to the embodiment.

FIG. 7 is a diagram illustrating an example of the waveform of the signal obtained in the process of the inspection processing in the signal processing method according to the embodiment.

FIG. 8A is a diagram illustrating an example of waveforms of a plurality of detection signals obtained in the process of the signal processing method according to the embodiment.

FIG. 8B is a diagram illustrating an example of the waveforms of the plurality of detection signals obtained in the process of the signal processing method according to the embodiment.

FIG. 9A is a diagram illustrating an example of a waveform of a detection signal obtained by the signal processing method according to the embodiment.

FIG. 9B is a diagram illustrating an example of the waveform of the detection signal obtained by the signal processing method according to the embodiment.

FIG. 10 is a graph illustrating an example of a waveform of the detection signal according to the embodiment.

FIG. 11 is a graph illustrating an example of a waveform of an inspection signal obtained by the signal processing method according to the embodiment.

FIG. 12 is a diagram illustrating an example of a waveform of a burst wave signal used in the signal processing method according to the embodiment.

FIG. 13 is a diagram illustrating an example of a waveform of the inspection signal obtained by the signal processing method according to the embodiment.

FIG. 14 is a diagram for explaining an effect obtained by the signal processing method according to the embodiment.

### DETAILED DESCRIPTION

Hereinafter, some embodiments of the present invention will be described by referring to the attached drawings. However, dimensions, materials, shapes, relative disposition and the like of components described as the embodiments or illustrated in the drawings are not intended to limit the scope of the present invention to them but are only examples for explanation.

In the following, an example in which the signal processing method and device for ultrasonic inspection according to some embodiments are applied to thickness measurement will be described, but the signal processing method and device according to the present invention can be applied also to ultrasonic inspection other than the thickness measurement. For example, the signal processing method and device according to some embodiments can be applied also to an ultrasonic flaw detecting device, an ultrasonic microscope and the like.

(Constitution of Thickness Measuring Device and Signal Processing Device)

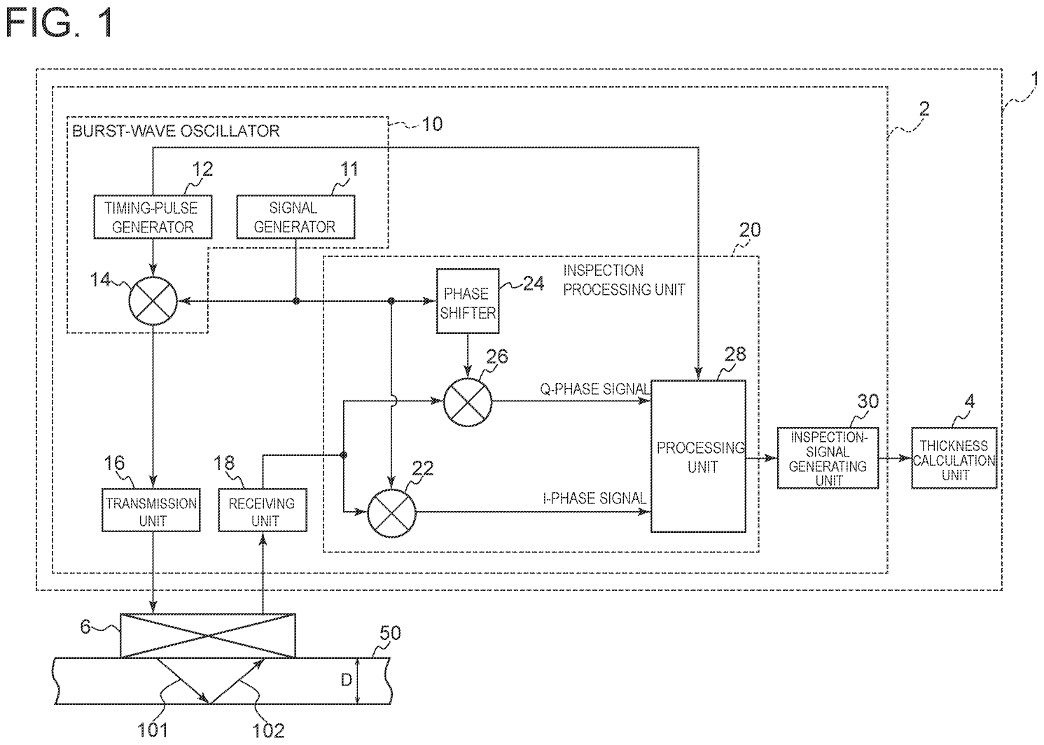

First, by referring to FIG. 1, a thickness measuring device including a signal processing device for ultrasonic inspection according to one embodiment will be schematically described. FIG. 1 is a schematic configuration diagram of the thickness measuring device including the signal processing device for ultrasonic inspection according to the embodiment. As shown in the figure, the thickness measuring device 1 includes a signal processing device 2 for generating an inspection signal by processing an electric signal used for the ultrasonic inspection of an inspection target (thickness measurement target) and a thickness calculation unit 4 constituted to calculate a thickness of the inspection target by using the generated inspection signal. In FIG. 1, a pipe 50 is illustrated as an example of the inspection target (thickness measurement target) of the thickness measuring device 1, and it is constituted so that the thickness of the pipe 50 is measured by the thickness measuring device 1, but the inspection target is not limited to a pipe but may be a plate material, for example.

The signal processing device 2 includes a burst-wave oscillator 10 constituted capable of oscillating a burst wave signal, a transmission unit 16 which causes the burst wave signal to inject an ultrasonic probe 6, a receiving unit 18 which receives a receiving signal from the ultrasonic probe 6, an inspection processing unit 20 for obtaining a detection signal by inspection processing of the receiving signal, and an inspection-signal generating unit 30 for generating an inspection signal on the basis of the detection signal. Elements (a signal generator 11, a timing-pulse generator 12, a mixer 14 and the like, which will be described later) constituting the oscillator 16, the receiving unit 18, and the burst-wave oscillator 10 and elements (a phase shifter 24, a processing unit 28 and the like, which will be described later) constituting the inspection processing unit 20 are electrically connected as shown in the figure.

The burst-wave oscillator 10 includes the signal generator 11 capable of generating a continuous sine-wave signal (electric signal), the timing-pulse generator 12 for generating a timing pulse which turns ON/OFF the signal from the signal generator 11 at a specified timing, and the mixer 14. By mixing the continuous sine-wave signal and the timing pulse by the mixer 14, a burst wave signal obtained by cutting out a specified length from the continuous sine-wave signal is generated. It may be so constituted that, instead of the timing-pulse generator 12, the burst wave may be generated by generating a timing pulse from the processing unit 28 which will be described later. Moreover, the generation of the burst wave can be realized also by using an analog switch instead of the mixer 14. The signal generator 11 is constituted capable of changing a frequency of the continuous sine-wave signal to be generated. That is, the burst-wave oscillator 10 is constituted capable of oscillating a plurality of burst wave signals with different frequencies (that is, the burst wave signals with the frequencies f₁, f₂, . . . f_{N}, where n≥2). The burst wave signal oscillated by the burst-wave oscillator 10 is configured to be sent to the transmission unit 16.

The transmission unit 16 is configured to apply the burst wave signal received from the burst-wave oscillator 10 to the ultrasonic probe 6. In order to drive the ultrasonic probe 6 appropriately, the transmission unit 16 may be configured to apply the burst wave signal from the burst-wave oscillator 10 to the ultrasonic probe after amplification.

The ultrasonic probe 6 is configured to be driven by the burst wave signal received from the transmission unit 16, to generate an ultrasonic wave, and to inject it to an inspection target (the pipe 50, for example). In FIG. 1, an incident wave (ultrasonic wave) 101 having injected the pipe 50, which is the inspection target, is illustrated. Moreover, the ultrasonic probe 6 is configured to receive a reflected wave 102 (see FIG. 1), which is the incident wave (ultrasonic wave) 101 having injected the inspection target and reflected on the inspection target, and to convert it to the receiving signal (electric signal). The ultrasonic probe 6 is constituted by a piezoelectric device. The receiving signal obtained by the ultrasonic probe 6 is sent to the receiving unit 18.

The receiving unit 18 is configured to send out the receiving signal received from the ultrasonic probe 6 to the inspection processing unit 20. In order to execute the inspection processing at the inspection processing unit 20 appropriately, the receiving unit 18 may be configured to send out the received signal from the ultrasonic probe 6 to the inspection processing unit 20 after amplification.

The inspection processing unit 20 is configured to execute the inspection processing of the receiving signal received from the receiving unit 18 and to obtain the detection signal. The detection signal is a detection signal indicating the reflected wave 102 from the inspection target and is a signal including information indicating a traveling time from application of the burst wave signal by the transmission unit 16 to the ultrasonic probe 6 to reception of the receiving signal of the reflected wave 102 at the receiving unit 18 and a signal level (detection voltage) of the reflected wave 102.

FIG. 1 shows an example of the inspection processing unit 20 according to some embodiments. The inspection processing unit 20 shown in FIG. 20 includes mixers 22, 26 for mixing the receiving signal from the receiving unit 18 and a continuous sine-wave signal from the signal generator 11, the phase shifter 24 for shifting a phase of the continuous sine-wave signal from the signal generator 11, and the processing unit 28.

In the mixer 22, the receiving signal from the receiving unit 18 and the continuous sine-wave signal from the signal generator 11 are mixed, and an I-phase signal (In-phase signal) is obtained. Moreover, in the mixer 26, the receiving signal from the receiving unit 18 and the continuous sine-wave signal from the signal generator 11 are mixed with a signal whose phase was shifted only by 90 degrees by the phase shifter 24, and a Q-phase signal (Quadrature-phase signal) is obtained. The I-phase signal and the Q-phase signal obtained as above are sent to the processing unit 28. It may be so configured that the I-phase signal and the Q-phase signal based on the receiving signal are sent to the processing unit 28 after being attenuated by an attenuator or after a frequency component of the inspection target is amplified by an intermediate-frequency amplifier. In the processing unit 28, inspection is conducted on the basis of the I-phase signal and the Q-phase signal, and the detection signal indicating the reflected wave 102 is taken out of the receiving signal.

In the inspection processing unit 20, the detection signal according to the frequency of the burst wave signal is obtained. That is, when the ultrasonic waves based on the burst wave signals with the frequencies f₁, f₂, . . . , f_{N} are caused to inject the same inspection target (the pipe 50, for example) by the burst-wave oscillator 10, the inspection processing unit 20 executes the inspection processing of the receiving signals corresponding to the burst wave signals with the frequencies f₁, f₂, . . . , f_{N}, respectively, whereby a plurality of the detection signals SD₁, SD₂, . . . , SD_{N} corresponding to the burst wave signals with the frequencies f₁, f₂, . . . , f_{N} are obtained.

The detection signal obtained in the inspection processing unit 20 is sent out to the inspection-signal generating unit 30.

The inspection-signal generating unit 30 is configured to generate an inspection signal for obtaining an inspection result (a thickness, for example) related to the inspection target (the pipe 50, for example) on the basis of the plurality of detection signals (the detection signals SD₁, SD₂, . . . , SD_{N} corresponding to the burst wave signals with the frequencies f₁, f₂, . . . , f_{N}, respectively) received from the inspection processing unit 20. The inspection signal generated in the inspection-signal generating unit 30 is sent out to a thickness calculation unit 4. A procedure for generating the inspection signal on the basis of the plurality of detection signals in the inspection-signal generating unit 30 will be described later.

The thickness calculation unit 4 is configured to calculate a thickness of the inspection target (the pipe 50, for example) on the basis of the inspection signal received from the inspection-signal generating unit 30. The thickness D of the inspection target (the pipe 50, for example) can be expressed by the following formula (A) by using a speed of sound cₛ in a material of the inspection target and time T from incidence of the ultrasonic wave from the ultrasonic probe 6 to the inspection target to reception by the ultrasonic probe 6 of the reflected wave from the inspection target:

cₛ×T=2D (A)

The aforementioned time T can be obtained from the inspection signal. Therefore, the thickness calculation unit 4 may be configured to calculate the thickness D of the inspection target on the basis of the aforementioned formula.

(Signal Processing Device and Signal Processing Method)

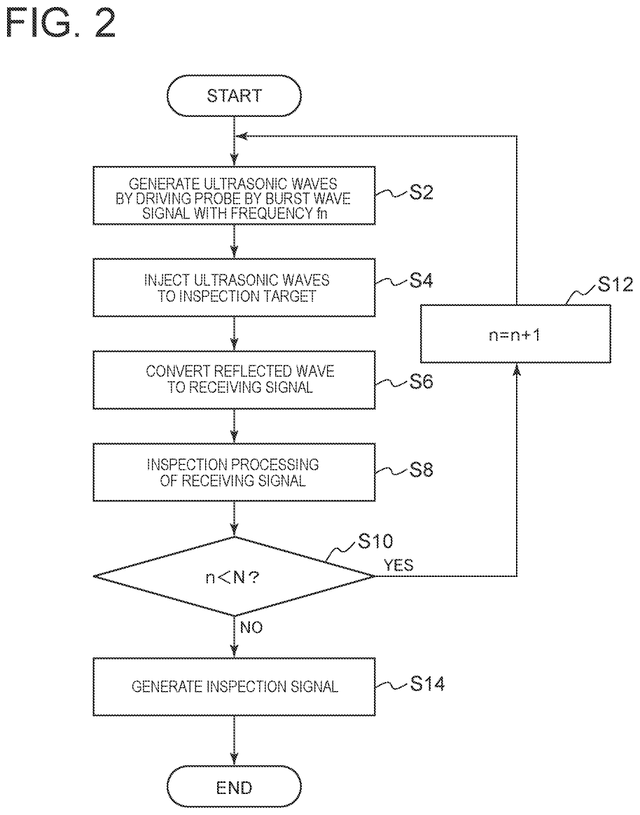

Subsequently, the signal processing method according to some embodiments will be described along the flowchart shown in FIG. 2. In the following, a case where the signal processing method according to the one embodiment is executed by the aforementioned signal processing device 2 will be described, but the signal processing method according to some embodiments may be executed by the other means.

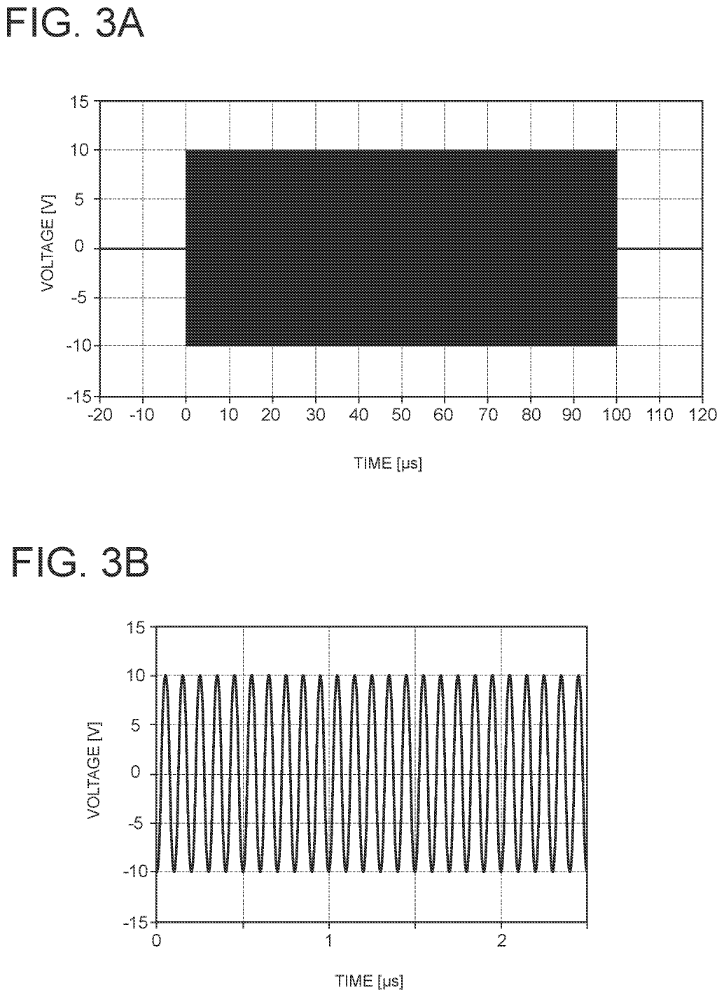

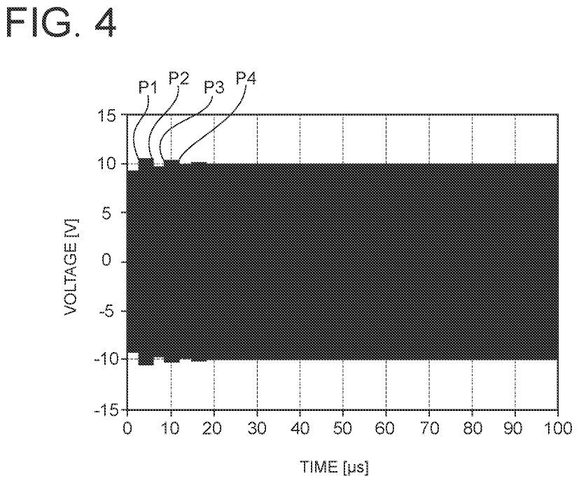

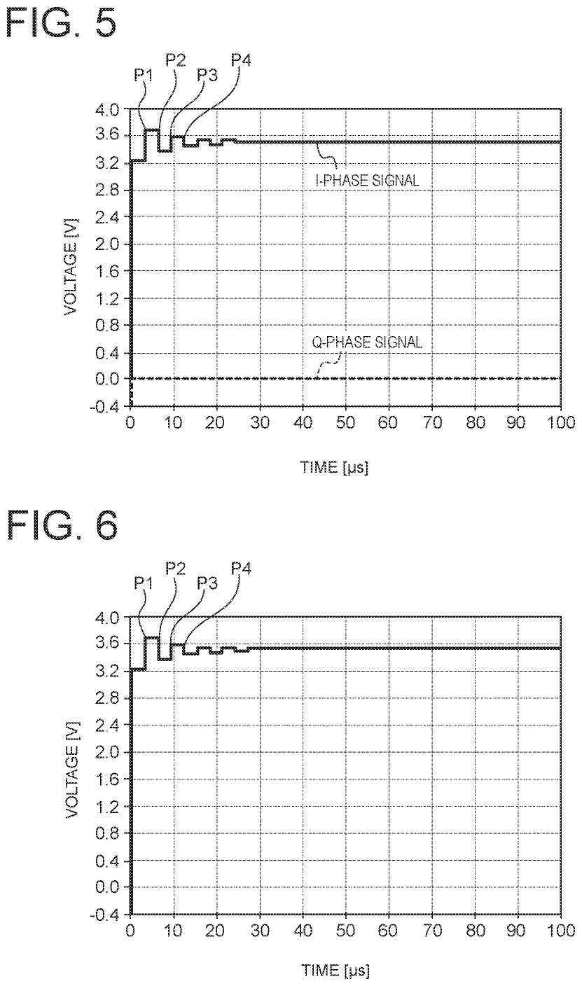

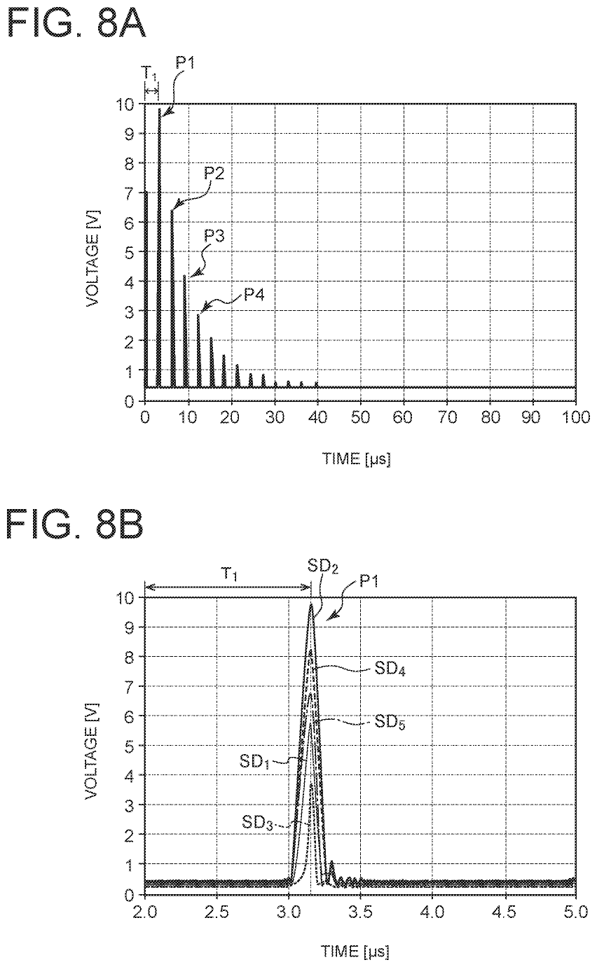

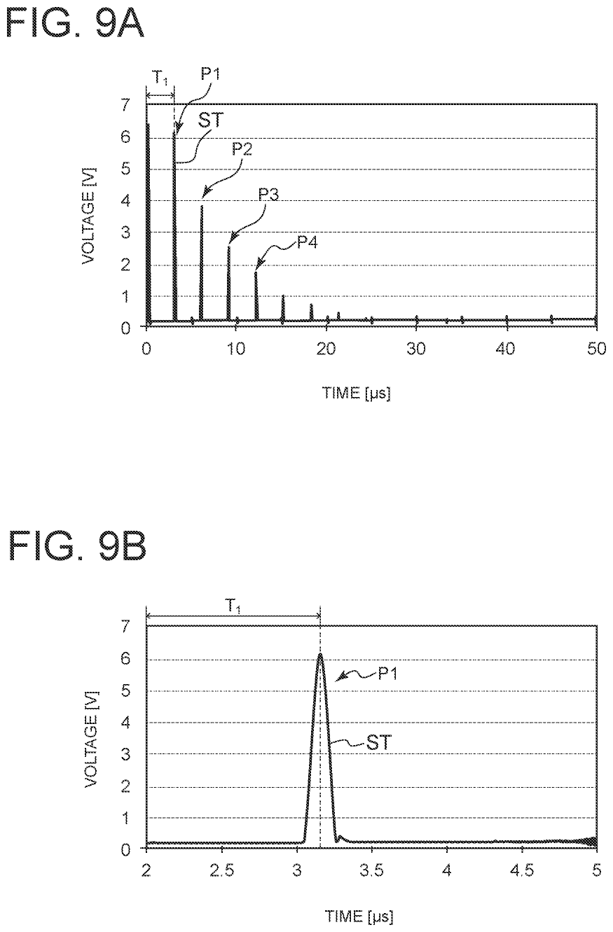

FIG. 2 is a flowchart of the signal processing method according to the one embodiment. FIG. 3A and FIG. 3B are diagrams illustrating examples of waveforms of the burst wave signals used in the signal processing method according to the one embodiment. FIG. 4 is a diagram illustrating an example of the waveform of the receiving signal obtained in a process of the signal processing method according to the one embodiment. FIGS. 5 to 7 are diagrams illustrating examples of the waveforms of the signals obtained in the process of the inspection processing in the signal processing method according to the one embodiment, respectively. FIG. 8A and FIG. 8B are diagrams illustrating examples of the waveforms of a plurality of detection signals obtained in the process of the signal processing method according to the one embodiment. FIG. 9A and FIG. 9B are diagrams illustrating examples of the waveform of the for the inspection signal obtained by the signal processing method according to the one embodiment. Horizontal axes of the graphs showing the waveforms in FIGS. 5 to 9B indicates time, and vertical axes indicate voltages. Moreover, a point of time at time zero in the graph is time when application of the burst wave signal to the ultrasonic probe 6 is started, and incidence of the ultrasonic waves is started.

In the signal processing method according to the one embodiment, first, by oscillating the burst wave signal of the specified frequency f1 (n=1) from the burst-wave oscillator 10 and by applying the burst wave signal to the ultrasonic probe 6 through the transmission unit 16 so as to drive the ultrasonic probe 6, the ultrasonic waves are generated (Step S2). Moreover, the ultrasonic waves generated at Step S2 are caused to inject the inspection target (the pipe 50, for example) (Step S4).

The burst wave signal oscillated from the burst-wave oscillator 10 at Step S2 may be a continuous sine-wave signal as shown in FIG. 3A and FIG. 3B, for example. FIG. 3B shows the horizontal axis (time axis) of the graph showing the burst wave signal shown in FIG. 3A in an enlarged manner.

Subsequently, in the ultrasonic probe 6, a reflected wave 102 (see FIG. 1) obtained by reflecting on the inspection target the incident wave (ultrasonic wave) 101 having injected the inspection target at Step S4 is received and is converted to a receiving signal (electric signal) (Step S6). The receiving signal obtained at Step S6 is a receiving signal corresponding to the burst wave signal with the frequency f1 used at Step S2.

The receiving signal obtained at Step S6 has a waveform as shown in FIG. 4, for example, and a rapid change in a voltage of the receiving signal is seen at the time when the reflected wave is received. Points P1 to P4 shown in the graphs in FIG. 4 and FIG. 5 to FIG. 9B, which will be described later, indicate reception of the reflected waves, which were the ultrasonic waves having injected the inspection target and reflected once to four times on a bottom surface of the inspection target (that is, the ultrasonic waves which reciprocated once to four times between a front surface and the bottom surface of the inspection target, respectively, and returned to the front surface of the inspection target). Since intensity of the reflected wave becomes smaller each time the reflection is repeated on the inspection target, the voltage of the receiving signal indicating the reflected wave in FIG. 4 (the voltages at the points P1 to P4) gradually becomes smaller. Moreover, the graphs in FIG. 4 to FIG. 9B show that a plurality of the reflected waves with the intensities further smaller are detected at the time of the point P4 and after.

Subsequently, in the inspection processing unit 20, by executing the inspection processing of the aforementioned receiving signal (receiving signal corresponding to the burst wave signal with the frequency f1) received through the receiving unit 18, the detection signal (see FIG. 8) is obtained (Step S8). The detection signal obtained at Step S8 is the detection signal SD₁ corresponding to the burst wave signal with the frequency f1 used at Step S2.

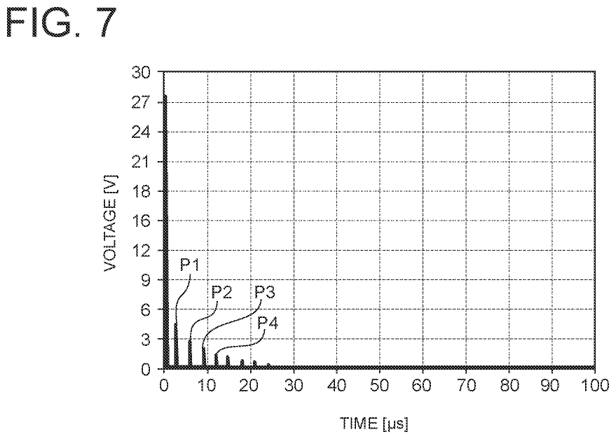

At Step S8, the I-phase signal and the Q-phase signal are generated on the basis of the receiving signal from the receiving unit 18 and the continuous sine-wave signal from the signal generator 11, for example (see FIG. 5), and by executing synthesizing processing of the generated I-phase signal and Q-phase signal, an amplitude component of the receiving signal is taken out (see FIG. 6). FIG. 5 is a graph illustrating examples of the waveforms of the I-phase signal and the Q-phase signal obtained at Step S8, and FIG. 6 is a graph illustrating an example of the waveform of the signal obtained by the synthesizing processing of the I-phase signal and the Q-phase signal. And by executing differential processing and absolute-value processing of the signal obtained by the synthesizing processing, the detection signal shown in FIG. 7 is obtained.

By means of the aforementioned Steps S2 to S8, the detection signal SD₁ corresponding to the burst wave signal with the frequency f₁ is obtained.

Subsequently, the frequency of the burst wave signal is changed to the specified frequency f₂ (Steps S10 to S12), and similarly to the case of the aforementioned frequency f₁ of the burst wave signal, Steps S2 to S8 are executed, and the detection signal SD₂ corresponding to the burst wave signal with the frequency f₂ is obtained.

Similarly, the frequency of the burst wave signal is changed up to the specified frequency f_{N} (Steps S10 to S12), and at each time, similarly to the case of the aforementioned frequency f₁ of the burst wave signal, Steps S2 to S8 are executed. As described above, the plurality of detection signals SD₁, SD₂, . . . , SD_{N} corresponding to the burst wave signals with the frequencies f₁, f₂, . . . , f_{N}, respectively, are obtained. The intensity of each of the burst wave signals with the frequencies f₁, f₂, . . . , f_{N} is preferably made the same.

FIG. 8A and FIG. 8B are graphs illustrating the plurality of detection signals SD₁ to SD_{N} obtained as above in a superimposed manner. FIG. 8B illustrates a part including a time slot in which the first reflective wave (indicated by P1) is observed in an enlarged manner in the graph in FIG. 8A. However, in FIG. 8A and FIG. 8B, for simplification of the graphs, the number N of types of the frequencies of the burst wave signal=5 for convenience, but actually, the aforementioned number N of types of the frequencies may be smaller or larger than 5.

A peak appearing in the vicinity of time 0 [μs] in the graph in FIG. 8A and FIG. 9A, which will be described later, indicates the burst wave signal itself oscillated from the transmission unit 16 but not the receiving signal based on the reflected wave.

As shown in FIG. 8B, time when the voltage peak indicating the first reflected wave (P1) appears in each of the plurality of detection signals SD₁ to SD_{N} (traveling time from incidence start time (t=0) of the ultrasonic waves) substantially coincides, but intensities of the voltage peaks (signal levels) are different from each other. In the graph shown in FIG. 8B, in the plurality of detection signals SD₁ to SD₅, the signal level (voltage peak level) of the detection signal SD₂ is the largest, and the signal level (voltage peak level) of the detection signal SD₃ is the smallest.

Though not particularly illustrated, in the second reflected wave and after, too, the feature that the time when the voltage peak appears substantially coincide, but the voltage levels at the peaks are different from each other is similar to that of the first reflected wave.

And at Step S14, the inspection signal ST for obtaining an inspection result related to the inspection target (a thickness of the inspection target, for example) is generated from the plurality of detection signals SD₁ to SD_{N} obtained as above.

FIG. 9A and FIG. 9B are graphs illustrating the inspection signal ST, which is an average value of the signal levels of the plurality of detection signals SD₁ to SD₅ illustrated in FIG. 8A and FIG. 8B as an example of the inspection signal ST generated at Step S14. FIG. 9B illustrates a part including a time slot in which the first reflected wave (indicated by P1) is observed in the graphs in FIG. 9A in an enlarged manner.

As shown in FIG. 9A and FIG. 9B, the time when the voltage peak indicating the first reflected wave (P1) appears in the inspection signal ST (traveling time from incidence start time (t=0) of the ultrasonic waves) is Ti. Therefore, by using this Ti, for example, the thickness of the inspection target (the pipe 50, for example) can be calculated on the basis of the aforementioned formula (A).

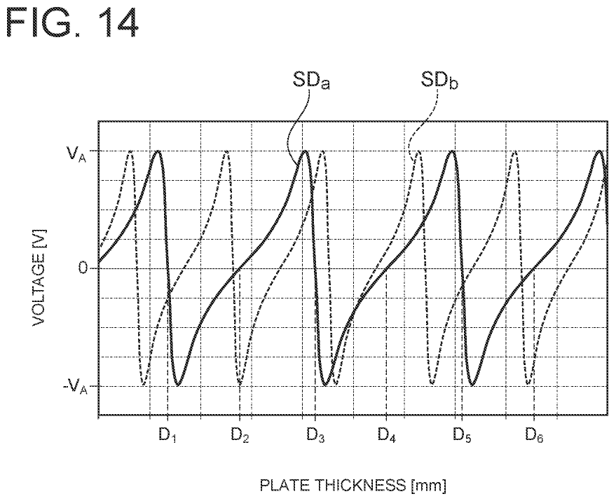

Here, FIG. 14 is a diagram for explaining an effect that can be obtained by the signal processing method according to the aforementioned embodiment. FIG. 14 is a graph illustrating a relationship between the thickness of the inspection target and the signal level (voltage peak level indicating the reflected wave) of the detection signal obtained on the basis of each of the burst frequencies (detection signal obtained similarly to the aforementioned Steps S2 to S8) when the thickness measurement is conducted by using the burst wave signal for a detection target. FIG. 14 illustrates a graph of the detection signal SDₐ obtained on the basis of the burst wave signal with the frequency fₐ and a graph of the detection signal SD_{b} obtained on the basis of the burst wave signal with the frequency f_{b} (fₐ≠f_{b}).

In the ultrasonic inspection using the burst wave signal, the signal level (voltage) of the detection signal obtained by inspection processing of the receiving signal based on the reflected wave is fluctuated by interference between the incident wave to the inspection target and the reflected wave from the inspection target depending on the thickness of the inspection target and the like. For example, as shown in FIG. 14, when the burst wave signal with a specific frequency (fₐ or f_{b}, for example) is to be used, the signal level of the aforementioned detection signal (SDₐ or SD_{b}, for example) obtained on the basis of the burst wave signal periodically fluctuates in relation with the thickness of the inspection target within a range of a certain fluctuation width (V_{A} in FIG. 14).

Here, when an absolute value of the signal level of the detection signal corresponding to the actual thickness D of the inspection target is in the vicinity of the maximum value (V_{A} in FIG. 14), the thickness D of the inspection target can be appropriately obtained on the basis of the detection signal, while when the absolute value of the signal level of the detection signal corresponding to the actual thickness D of the inspection target is in the vicinity of zero, it is difficult to appropriately obtain the thickness D of the inspection target on the basis of the detection signal. That is, when the burst wave signal with the frequency fₐ is used, the detection signal SDₐ obtained on the basis of the burst wave signal has the signal level at zero in the thicknesses D₁ to D₆ as shown in FIG. 14, and there is a possibility that it is buried in a noise. Thus, when the actual thickness of the inspection target is any one of D₁ to D₆ or in the vicinity of D₁ to D₆, in the case where the burst wave signal with the frequency fₐ is used, it is difficult to appropriately obtain the aforementioned time T (time T from the incidence of the ultrasonic wave from the ultrasonic probe 6 to the inspection target to reception of the reflected wave by the ultrasonic prove 6 from the inspection target) and thus, appropriate measurement of the thickness of the inspection target is difficult.

On the other hand, the signal level of the detection signal SD_{b} obtained on the basis of the burst wave signal with the frequency f_{b} different from the frequency fₐ is, as shown in FIG. 14, fluctuates within the same fluctuation width (V_{A}) as the detection signal based on the frequency fₐ but in a cycle different from the detection signal based on the burst wave signal with the frequency fₐ. Thus, when the thickness of the inspection target is the thickness D₁ to D₆ where the signal level of the detection signal becomes zero when the burst wave signal with the frequency fₐ is used, an absolute value of the signal level of the detection signal based on the burst wave signal with the frequency f_{b} is normally a value larger than zero, and can be discriminated from a noise easily. Thus, when the actual thickness of the inspection target is any one of D₁ to D₆ or in the vicinity of D₁ to D₆, the aforementioned time T can be appropriately obtained by using the burst wave signal with the frequency f_{b} and thus, the thickness of the inspection target can be appropriately measured easily.

In this point, according to the method according to the aforementioned embodiment, by using a plurality of the burst wave signals with different frequencies (that is, the burst wave signal with any one of the frequencies f₁ of f_{N}), respectively, for an inspection target (the pipe 50, for example), the plurality of detection signals SD₁ to SD_{N} corresponding to the plurality of burst wave signals, respectively, are obtained, and the inspection signal ST is generated. Therefore, by using the inspection signal ST generated as above, the aforementioned time T (time T from the incidence of the ultrasonic wave from the ultrasonic probe 6 to the inspection target to reception of the reflected wave by the ultrasonic prove 6 from the inspection target) can be obtained appropriately on the basis of the peak voltage of the inspection signal ST regardless of the thickness of the like of the inspection target, and the thickness or the like of the inspection target can be measured appropriately. Thus, the thickness or the like of the inspection target can be measured appropriately by using the electric signal (burst wave signal) at a lower voltage as compared with the case where the impulse is used and thus, appropriate ultrasonic inspection (measurement) can be conducted even under an inflammable gas atmosphere or the like. Moreover, it can be suitably applied to continuous thickness measurement of the inspection target whose thickness can change with elapse of time (a pipe which can be thinner by erosion or the like with elapse of time, for example), for example.

In some embodiments, at the aforementioned Step S14, the aforementioned inspection signal ST is generated on the basis of the statistic amount of the signal levels of the plurality of detection signals SD₁ to SD_{N} corresponding to the plurality of burst wave signals with different frequencies (frequencies f₁ to f_{N}). The aforementioned statistic amount may be an average value, a maximum value, an n-th maximum value, a median value and the like of the signal levels of the plurality of detection signals SD₁ to SD_{N}.

In this case, by using the statistic amount of the signal levels of the plurality of detection signals SD₁ to SD_{N}, the inspection signal ST considering the detection signal with a relatively high signal level other than the level minimum signal can be generated. Thus, measurement can be conducted appropriately regardless of the thickness or the like of the inspection target.

For example, at the aforementioned Step S14, the inspection signal ST may be generated on the basis of a summation value or an average value of the signal levels of the plurality of detection signals SD₁ to SD_{N}. The inspection signal ST illustrated in FIG. 9B is obtained as the average value of the signal levels of the detection signals SD₁ to SD₅ shown in FIG. 8B.

In this case, by using the summation value or the average value of the signal levels of the plurality of detection signals SD₁ to SD_{N}, the inspection signal ST considering the detection signal with a relatively high signal level other than the level minimum signal can be generated. Thus, measurement can be conducted appropriately regardless of the thickness or the like of the inspection target. Since the signal levels of the detection signals are periodically changed with respect to the frequency change of the burst wave signal, the summation value or the average value of the signal levels of the plurality of detection signals become a value close to a predetermined value regardless of the thickness or the like of the inspection target, and the measurement of the inspection target can be conducted more reliably.

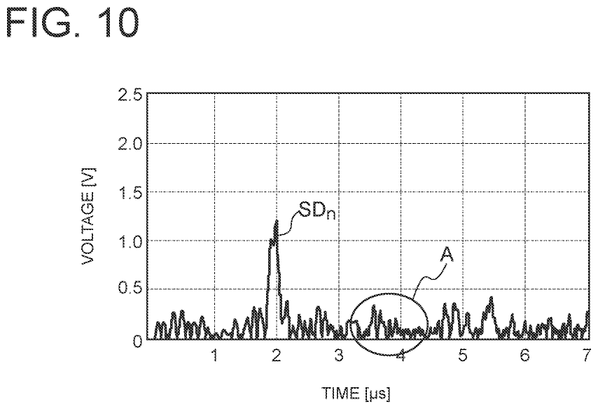

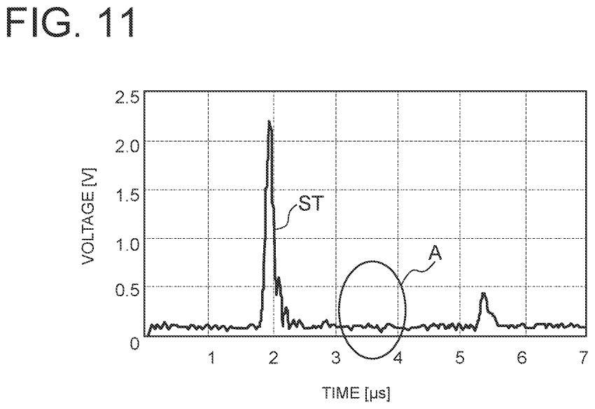

Here, FIG. 10 is a graph illustrating an example of the waveform of the specific detection signal SDn in the plurality of detection signals SD₁ to SD_{N}, and FIG. 11 is a graph illustrating an example of the waveform of the inspection signal ST (the inspection signal ST according to the aforementioned embodiment) obtained as the average value of the plurality of detection signals SD₁ to SD_{N}.

When the ultrasonic waves propagate in a member, a disturbance noise is generated due to micro scattering, reflection and the like in the middle of the propagation. In the detection signal SDn based on the burst wave signal with a specific frequency fn, as shown in FIG. 10, the disturbance noise (waveform in a region indicated by A in the figure, for example) other than the peak value indicating the reflected wave of the ultrasonic wave remarkably appears. Since the similar disturbance noise appears even if the detection signal is repeatedly obtained by using the burst wave signal with the same frequency fn, an S/N ratio is not improved even if such repeatedly obtained detection signals are averaged.

On the other hand, a propagation state of the ultrasonic waves in the member is changed if the frequency of the burst wave signal is changed. Thus, as in the aforementioned embodiment, with the inspection signal ST obtained as the average value of the plurality of detection signals SD₁ to SD_{N}, the disturbance noise (the waveform in the region indicated by A in FIG. 11, for example) in each of the detection signals SD₁ to SD_{N} are also averaged, and as shown in FIG. 11, the S/N ratio of the peak signal with respect to the disturbance noise is improved. Therefore, the measurement by the ultrasonic inspection can be conducted more accurately. When the inspection signal ST obtained as the summation value of the plurality of detection signals SD₁ to SD_{N}, too, the similar effect can be obtained.

Moreover, at the aforementioned Step S14, the inspection signal may be generated on the basis of the maximum value of the signal levels of the plurality of detection signals SD₁ to SD_{N} (the signal level of the detection signal SD₂ in the case shown in FIG. 8B, for example), for example.

In this case, by using the maximum value of the signal levels of the plurality of detection signals SD₁ to SD_{N}, the inspection signal ST considering the detection signal with the relatively highest signal level in the plurality of detection signals SD₁ to SD_{N} can be generated. Thus, the measurement can be conducted appropriately regardless of the thickness or the like of the inspection target.

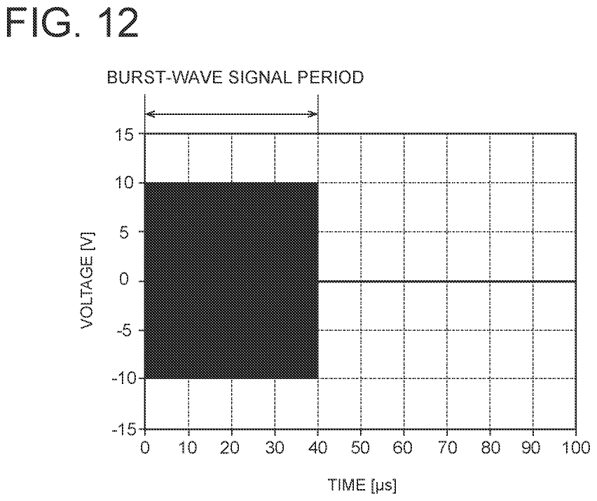

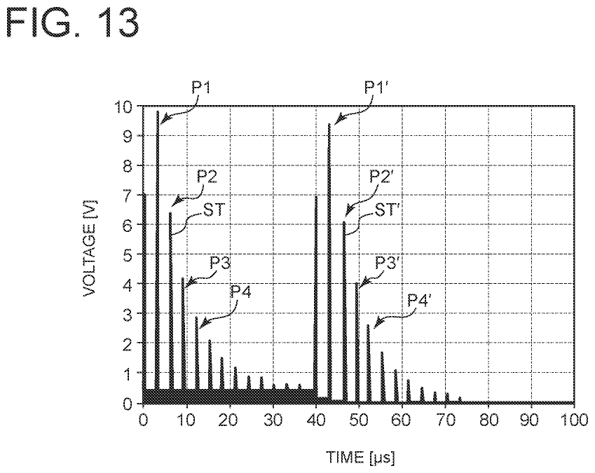

FIG. 12 is a diagram illustrating an example of the waveform of the burst wave signal used in the signal processing method according to the one embodiment. FIG. 13 is a diagram illustrating an example of the waveform of the inspection signal obtained by the signal processing method according to the one embodiment.

In the one embodiment, at the aforementioned Step S6, it may be so configured that, after the application of the burst wave signal oscillated from the burst-wave oscillator 10 to the ultrasonic probe 6 is finished, the reflected wave 102 from the inspection target is received at the ultrasonic probe 6.

In the example shown in FIG. 12, for example, during a period from time 0 μs to 40 μs, the burst wave signal (the burst wave signal similar to those shown in FIG. 3A and FIG. 3B) from the burst-wave oscillator 10 is applied to the ultrasonic probe 6, the application of the burst wave signal is finished at the time 40 μs, and after that, the burst wave signal is not applied to the ultrasonic probe 6.

When the burst wave signal is applied to the ultrasonic probe 6 as shown in FIG. 12, an inspection signal ST′ (inspection signal at time 40 μs and after) obtained on the basis of the receiving signal of the reflected wave detected by the ultrasonic probe 6 after the application of the burst wave signal is finished is the one shown in FIG. 13. This inspection signal ST′ includes voltage peaks P1′ to P4′ and the like indicating the reception of the reflected wave reflected once to four times on the bottom surface of the inspection target after the application of the burst wave signal is finished.

In FIG. 12 and FIG. 13, the inspection signal ST obtained on the basis of the receiving signal of the reflected wave detected by the ultrasonic probe 6 during the period from time 0 μs to 40 μs is similar to the inspection signal ST shown in FIG. 8A and FIG. 5B and includes the voltage peaks P1 to P4 and the like indicating the reception of the reflected wave reflected once to four times on the bottom surface of the inspection target during the application of the burst wave signal.

The receiving signal obtained by receiving the reflected wave from the inspection target in a state where the burst wave signal is being applied to the ultrasonic probe 6 is superimposed with the transmission signal (burst wave signal) and thus, if the receiving signal becomes small, it is masked by the transmission signal, and detection of the receiving signal becomes difficult. In this point, according to the aforementioned embodiment, it is configured such that the reflected wave from the inspection target (the pipe 50 or the like) is received after the application of the burst wave signal to the ultrasonic probe 6 is finished and thus, the receiving signal and the detection signals SD₁ to SD_{N} not affected by the transmission signal can be obtained. Thus, the S/N ratio of the inspection signal ST can be further improved and thus, the measurement accuracy can be improved.

Each of the frequencies f₁ to f_{N} of the plurality of burst wave signals (burst wave signal generated at Step S2) used in the method according to the embodiment described above may be set appropriately in accordance with the thickness D of the inspection target (the pipe 50, for example) or may be set as described below, for example.

Assuming that the thickness of the inspection target is Dₘᵢₙ or more at the smallest, a minimum path length of the ultrasonic wave in the inspection target is 2×Dₘᵢₙ. That is, assuming that the speed of sound in the material of the inspection target is cs, an amount of phase change θₐ with the minimum frequency fₐ of the burst wave signal can be expressed by the following formula (B):

θₐ=2Dₘᵢₙ/Cs×fₐ (B)

On the other hand, the phase rotation amount θ_{b} at the maximum frequency f_{b} can be expressed by the following formula (C):

θ_{b}=2Dₘᵢₙ/Cs×f_{b} (C)

Here, a condition that the inspection signal is sufficiently changed, and averaging becomes effective is the following formula (D):

θ_{b}−θₐ≥π/2 (D)

Therefore, a width Δf of f_{b} and the frequency fₐ is determined by the following formula (E):

Δf=f_{b}−fₐ≤π/2×Cs/(2Dₘᵢₙ)=Cs/Dₘᵢₙ×π/4 (E)

From the viewpoint of the detection efficiency, the central frequency (f_{b}−fₐ)/2 preferably should be selected at the center of the central frequency of the ultrasonic probe 6. Similarly, from the viewpoint of the detection efficiency, Δf is also preferably set within a bandwidth of the ultrasonic probe 6.

That is, by using the burst wave signals in plural in the frequency band within a range of such a degree that the width Δf of the frequency is expressed by the aforementioned formula (E), the detection signal SD having various signal levels can be obtained correspondingly to the thickness of the inspection target. Moreover, regarding the inspection target with the thickness larger than Dₘᵢₙ, by using a plurality of the burst wave signals in the frequency band within the range of the approximate width Δf acquired as above, the detection signals SD having the various signal levels can be obtained.

A pitch (interval) of each frequency fn (f₁, f₂, . . . , f_{N}) of the burst wave signal within the range of the aforementioned width Δf can be the one obtained by dividing the aforementioned width Δf into 10 to 20 parts. As a result, the detection signal SD having the various signal levels including the relatively large voltage level corresponding to each thickness of the inspection target can be obtained, and appropriate inspection signals can be obtained easily.

As an example, assuming that the thickness of the pipe 50 as the inspection target has at least 5 mm or more, by substituting Dₘᵢₙ: 5×10⁻³ [m] and the speed of sound cs: 5.92×10³ [m/s] in the case where the pipe 50 is made of steel into the aforementioned formula (E), the aforementioned frequency width Δf is calculated as approximately 0.94 MHz. Moreover, if this Δf is divided into 20 parts (N=20), for example, the pitch (interval) of each frequency fn of the plurality of burst wave signals is approximately 50 kHz. Therefore, as the frequency of the plurality of burst wave signals, by using each frequency fn with the pitch set to 50 kHz for f₁=10 MHz to f₂₀=11 MHz in the signal processing method according to the embodiment described above, the inspection signal ST which can appropriately calculate the thickness of the pipe 50 can be obtained.

Contents described in each of the embodiments are grasped as follows, for example.

(1) The signal processing method for ultrasonic inspection according to at least one embodiment of the present invention includes

a step (Steps S2, S4 described above, for example) of generating ultrasonic waves by driving the ultrasonic probe (6) by using the plurality of burst wave signals with different frequencies, respectively, and causing the ultrasonic waves to inject the inspection target,

a receiving step (Step S6 described above, for example) of receiving the plurality of reflected waves corresponding to the plurality of burst wave signals having injected the inspection target, respectively,

a step (Step S8 described above, for example) of obtaining the plurality of detection signals by executing the inspection processing of the receiving signals of the plurality of reflected waves corresponding to the plurality of burst wave signals, respectively, and

a generating step (Step S14 described above, for example) of generating the inspection signal for obtaining an inspection result related to the inspection target by using the plurality of detection signals.

In the ultrasonic inspection using the burst wave signal, a level (voltage) of the detection signal obtained by inspection processing of the receiving signal based on the reflected wave can be zero or a small value in the vicinity of zero in some cases due to interference of the incident wave into the inspection target and the reflected wave from the inspection target depending on the thickness or the like of the inspection target. In this point, according to the aforementioned method (1), for an inspection target, a plurality of inspection signals corresponding to the plurality of burst wave signals, respectively, are obtained by using the plurality of burst wave signals with different frequencies, respectively, and the inspection signal is generated by using the plurality of detection signals. That is, the plurality of detection signals having the different signal levels according to the frequency of the burst wave signal are obtained, and the inspection signal is generated by using the plurality of detection signals. Therefore, by using the inspection signal generated as above, appropriate measurement can be conducted regardless of the thickness or the like of the electric signal (burst wave signal). Thus, the inspection target can be appropriately measured by using the electric signal (burst wave signal) with a relatively low voltage, for example, and thus, the appropriate ultrasonic inspection (measurement) can be conducted even under the inflammable gas atmosphere or the like.

(2) In some embodiments, in the method of the aforementioned (1),

in the generating step, the inspection signal is generated on the basis of the statistic amount of the signal levels of the plurality of detection signals.

According to the aforementioned method (2), by using the statistic amount of the signal levels of the plurality of detection signals, the inspection signal can be generated. Thus, the measurement can be conducted appropriately regardless of the thickness or the like of the inspection target.

(3) In some embodiments, in the aforementioned method (2),

in the generating step, the inspection signal is generated on the basis of the summation value of the signal levels of the plurality of detection signals.

(4) In some embodiments, in the aforementioned method (2) or (3),

in the generating step, the inspection signal is generated on the basis of the average value of the signal levels of the plurality of detection signals.

According to the aforementioned method (3) or (4), by using the summation value or the average value of the signal levels of the plurality of detection signals, the inspection signal can be generated. Thus, the measurement can be conducted appropriately regardless of the thickness or the like of the inspection target. Since the signal level of the detection signal is changed periodically with respect to the frequency change of the burst wave signal, the summation value or the average value of the signal levels of the plurality of detection signals becomes a value close to a predetermined value regardless of the thickness or the like of the inspection target and thus, the measurement of the inspection target can be conducted more reliably.

Moreover, when the frequency of the burst wave signal is changed, the frequency of the ultrasonic wave caused to inject the inspection target is also changed, and the propagation state of the ultrasonic waves in the inspection target is changed. In this point, according to the aforementioned method (3) or (4), by summating or averaging the signal levels of the plurality of detection signals obtained by changing the frequency of the burst wave signal, the S/N ratio to the disturbance noise of the inspection signal can be improved, and the measurement accuracy can be improved.

(5) In some embodiments, in the aforementioned method (2),

in the generating step, the inspection signal is generated on the basis of the maximum value of the signal levels of the plurality of detection signals.

According to the aforementioned method (5), by using the maximum value of the signal levels of the plurality of detection signals, the inspection signal can be generated. Thus, the measurement can be conducted appropriately regardless of the thickness or the like of the inspection target.

(6) In some embodiments, in any one of the aforementioned methods (1) to (5),

in the receiving step, the reflected wave is received after the application of each of the burst wave signals to the ultrasonic probe is finished.

The receiving signal obtained by receiving the reflected wave from the inspection target in the state where the burst wave signal is applied to the ultrasonic probe is superimposed with the transmission signal (burst wave signal) and thus, if the receiving signal becomes small, it is masked by the transmission signal, and detection of the receiving signal becomes difficult. In this point, according to the aforementioned method (6), it is configured such that the reflected wave from the inspection target is received after the application of the burst wave signal to the ultrasonic probe is finished and thus, the receiving signal and the detection signal not affected by the transmission signal can be obtained. Therefore, the S/N ratio of the inspection signal can be further improved, and the measurement accuracy can be improved.

(7) The thickness measuring method according to at least one embodiment of the present invention includes

a step of obtaining an inspection signal by the signal processing method described in any one of the aforementioned (1) to (6), and a step of determining a thickness of the inspection target by using the inspection signal.

According to the aforementioned method (7), the inspection signal for obtaining a thickness of the inspection target by the method described in (1) is generated. Therefore, therefore, by using the inspection signal generated as above, the thickness of the inspection target can be measured appropriately regardless of the thickness of the inspection target.

(8) The signal processing device (2) for ultrasonic inspection according to at least one embodiment of the present invention includes

a burst wave oscillator (10) configured to be capable of oscillating a plurality of burst wave signals with different frequencies,

an ultrasonic probe (6) configured to generate ultrasonic waves by being driven by the burst wave signals so as to cause the ultrasonic waves to inject an inspection target and to receive reflected waves from the inspection target;

an inspection processing unit (20) configured to execute inspection processing of receiving signals of the plurality of reflected waves corresponding to the plurality of burst wave signals, respectively, and to obtain a plurality of detection signals, and

an inspection-signal generating unit (30) generating an inspection signal for obtaining an inspection result related to the inspection target by using the plurality of detection signals.

According to the configuration of the aforementioned (8), for an inspection target, a plurality of detection signals corresponding to the plurality of burst wave signals, respectively, are obtained by using the plurality of burst wave signals with different frequencies, respectively, and the inspection signal is generated by using the plurality of detection signals. That is, the plurality of detection signals having the different signal levels according to the frequency of the burst wave signal are obtained, and the inspection signal is generated by using the plurality of detection signals. Therefore, by using the inspection signal generated as above, appropriate measurement can be conducted regardless of the thickness or the like of the inspection target. Thus, the inspection target can be appropriately measured by using the electric signal (burst wave signal) with a relatively low voltage, for example and thus, the appropriate ultrasonic inspection (measurement) can be conducted even under the inflammable gas atmosphere or the like.

(9) The thickness measuring device (1) according to at least one embodiment of the present invention includes

the signal processing device (2) described in the aforementioned (8), and

a thickness calculation unit (4) configured to calculate a thickness of the inspection target by using the inspection signal obtained by the signal processing device.

According to the configuration of the aforementioned (9), the inspection signal for obtaining the thickness of the inspection target is generated by the signal processing device described in the aforementioned (8). Therefore, therefore, by using the inspection signal generated as above, the thickness of the inspection target can be measured appropriately regardless of the thickness of the inspection target.

The embodiment of the present invention has been described so far, but the present invention is not limited to the aforementioned embodiment but includes a form obtained by adding deformation to the aforementioned embodiment or a form combining these forms as appropriate.

In this description, expressions expressing relative or absolute disposition such as “in a direction”, “along a direction”, “parallel”, “orthogonal”, “center”, “concentric”, “coaxial” and the like express not only strictly such disposition but also a state with relative displacement with a tolerance or an angle or a distance of such a degree that the same function is obtained.

For example, the expressions expressing a state in which matters are equal such as “same”, “equal”, “uniform”, and the like express not only the strictly equal state but also the state in which a tolerance or a difference of such a degree that the same function is present.

Moreover, in this description, the expressions expressing shapes such as a square shape, a cylindrical shape and the like express not only the shapes such as a square shape or a cylindrical shape and the like in strictly geographical meaning but also shapes including irregular parts, chamfered parts and the like within a range by which the same effects are obtained.

Furthermore, in this description, expressions of “including”, “containing”, or “having” one constituent element are not exclusive expressions excluding presence of the other constituent elements.

### REFERENCE SIGNS LIST

1 Thickness measuring device
2 Signal processing device
4 Thickness calculation unit
6 Ultrasonic probe
10 Burst-wave oscillator
11 Signal generator
12 Timing-pulse generator
14 Mixer
16 Transmission unit
18 Receiving unit
20 Inspection processing unit
22 Mixer
24 Phase shifter
26 Mixer
28 Processing unit
30 Inspection-signal generating unit
50 Pipe
101 Incident wave (Ultrasonic wave)
102 Reflected wave (Ultrasonic wave)

1. A signal processing method for ultrasonic inspection, comprising:
a step of generating ultrasonic waves by driving an ultrasonic probe by using a plurality of burst wave signals with different frequencies, respectively, and causing the ultrasonic waves to inject an inspection target;
a receiving step of receiving a plurality of multiple reflected waves corresponding to the plurality of burst wave signals having injected the inspection target, respectively;
a step of obtaining a plurality of detection signals by executing detection processing of receiving signals of the plurality of multiple reflected waves corresponding to the plurality of burst wave signals, respectively; and
a generating step of generating an inspection signal for obtaining an inspection result related to the inspection target by using the plurality of detection signals.

2. The signal processing method according to claim 1, wherein
in the generating step, the inspection signal is generated on the basis of a statistic amount of signal levels of the plurality of detection signals.

3. The signal processing method according to claim 2, wherein
in the generating step, the inspection signal is generated on the basis of a summation value of signal levels of the plurality of detection signals.

4. The signal processing method according to claim 2, wherein
in the generating step, the inspection signal is generated on the basis of an average value of signal levels of the plurality of detection signals.

5. The signal processing method according to claim 2, wherein
in the generating step, the inspection signal is generated on the basis of a maximum value of signal levels of the plurality of detection signals.

6. The signal processing method according to claim 1, wherein
in the receiving step, each of the plurality of multiple reflected waves is received after application of each of the burst wave signals to the ultrasonic probe is finished.

7. A thickness measuring method, comprising:
a step of obtaining the inspection signal by the signal processing method according to claim 1; and
determining a thickness of the inspection target by using the inspection signal.

8. A signal processing device for ultrasonic inspection, comprising:
a burst wave oscillator configured to be capable of oscillating a plurality of burst wave signals with different frequencies;
an ultrasonic probe configured to generate ultrasonic waves by being driven by the burst wave signals so as to cause the ultrasonic waves to inject an inspection target and to receive a plurality of multiple reflected waves from the inspection target;
an inspection processing unit configured to execute inspection processing of receiving signals of the plurality of multiple reflected waves corresponding to each of the plurality of burst wave signals and to obtain a plurality of detection signals; and
an inspection-signal generating unit generating an inspection signal for obtaining an inspection result related to the inspection target by using at least the detection signal other than a minimum signal whose signal level is the smallest in the plurality of detection signals.

9. A thickness measuring device, comprising:
the signal processing device according to claim 8; and
a thickness calculating unit configured to calculate a thickness of the inspection target by using the inspection signal obtained by the signal processing device.
